(19) United States
(12) Patent Application Publication
(10) Pub. No.: US 2013/0282838 A1
(43) Pub. Date: Oct. 24, 2013

(54) GROUP SMS MESSAGING

(71) Applicant: Zhongwen Zhu, Saint-Laurent (CA)

(72) Inventor: Zhongwen Zhu, Saint-Laurent (CA)

(73) Assignee: TELEFONAKTIEBOLAGET L M ERICSSON (PUBL), Stockholm (SE)

(21) Appl. No.: 13/452,318

(22) Filed: Apr. 20, 2012

(51) Int. Cl. G06F 15/16

(52) U.S. Cl. 709/206

(57) ABSTRACT

A system and method for enabling a network messaging center to identify messages for further processing or distribution is provided. The source and destination addresses of a received message are compared to determine if the received message should be flagged for further processing, without forwarding the message to the indicated destination address. The further processing can include extracting recipient information from the received message determining how to distribute the message to each of the extracted recipients.

### TECHNICAL FIELD

This disclosure relates generally to mechanisms for identifying messages for further processing or distribution. In particular, this disclosure related to systems and methods for sending a group message to multiple users on multiple networks using existing telecommunication network user identities and nodes.

### BACKGROUND

Short Message Service (SMS) messaging is well known in the field of telecommunications. SMS is a text messaging service component of mobile communication systems, using standardized communications protocols, which allows the exchange of short text messages between mobile devices. When an SMS message is sent from a mobile device, it is received and stored by a Short Message Service Center (SMS-C). The SMS-C then forwards the SMS message towards the destination. If a recipient is not reachable, the SMS-C can queue the message for later retry. If the sender has addressed an SMS message to multiple recipients, the SMS-C will attempt to deliver a copy of the message to each of the recipients, one by one. To the recipient, the received message appears as a one-to-one message addressed from the sender to the recipient. The recipients have no indication that the message was a one-to-many communication.

Group SMS solutions have been proposed which rely on assigning a unique Mobile Station International Subscriber Directory Number (MSISDN), i.e. a phone number, to a defined group of users. Any messages sent to that assigned MSISDN are distributed to all members of the group. This solution requires the operator to maintain a pool of additional MSISDNs, which have associated costs and are limited in number.

Instant messaging clients are also well known in the field of online communications. They typically involve a server that allows two nodes to connect to each other for the purposes of a chat session. The data exchanged between the nodes is often relayed through the server, as shown in FIG. 1. Those skilled in the art will appreciate that in some embodiments the two user nodes can communicate directly with each other after being connected by the server. As illustrated in FIG. 1, a chat server 100 provides a service utilized by user 1 at node 102 and user 2 at node 104. Each of the user nodes 102 and 104 performs a login communication, 106a and 106b respectively, with the chat server 100. By logging into chat server 100, each user is able to obtain a list of users that are registered as online with chat server 100. User 1 node 102, upon obtaining an indication that user 2 is online, is able to send a message 108a to chat server 100 that is addressed to user 2. Chat server 100 can then forward the received message to user 2 at node 104 in message 108b. A reply 110 to message 108 (composed of messages 108a and 108b) can be sent as message 110a to the chat server 100 and message 110b from the chat server 100 to node 102 for review by user 1. As noted above, in some embodiments, it is possible for chat server 100 to extricate itself from the communications path, allowing messages 108 and 110 to be sent directly between node 102 and node 104.

As different chat services arose, there grew a demand for the chat services to interoperate with each other. Such a setup is illustrated in FIG. 2. User 1 at node 102 connects to chat server 1 112, while user 2 at node 104 connects to chat server 2 114. After users nodes 102 and 104 perform login processes 116 and 118, user 1 node 102 can issue message 120 to chat server 1 112, which then forwards the request as message 122 to chat server 2. Chat server 2 can acknowledge receipt of the message using ok message 124, and then forward the message to user 2 104 as message 126. Other mechanisms for allowing communication between individuals on chat services and other social networks will be known to those skilled in the art. Reply messages would take the same form as the initial message as will be well understood by those skilled in the art.

One consequence of users making use of a plurality of different communication services (e.g. SMS, email, instant messaging, social networks), is it is often difficult to communicate with a plurality of different users on a plurality of different systems in a single conversation. Although there has been some progress to allow interworking or inter-service chat, this is not always permitted. Even when it is permitted, it is typically restricted to a user-to-user interaction, and does not provide the user with the ability to create a group chat session across a plurality of different services.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a method of for identifying a message for further processing, comprising receiving, at a messaging center, a message from a source address addressed to a destination address; and responsive to determining a correlation between the source address and the destination address, flagging the received message for further processing without transmitting the received message to the destination address.

In an embodiment of the first aspect, the source address of the received message to the destination address of the received message can be compared. The step of determining the correlation between the source address and the destination address can include determining that the source address and the destination address are identical. The source address and the destination address can be Mobile Station International Subscriber Directory Numbers (MSISDNs) and the received message can be a Short Message Service (SMS) message. The received message can be forwarded to a messaging application server for further processing, in response to flagging the received message. The payload of the received message can include distribution information for use during the further processing. The distribution information can include an identifier associated with at least one recipient for the received message.

In a further embodiment of the first aspect, an identifier associated with a recipient can be extracted from the flagged message. A message distribution channel associated with the recipient can be determined in accordance with the extracted identifier. The flagged message can be transmitted to the recipient through the determined message distribution channel.

In a second aspect of the present invention, there is provided a network messaging center. The network messaging center comprises a processor and a communication interface. The communication interface is for receiving a message from a source address and addressed to a destination address. The processor for flagging the received message for further processing without transmitting the received message to the destination address, in response to determining a correlation between the source and destination addresses of the received message.

In an embodiment of the second aspect, the network messaging center further comprises a memory for storing the received message. The source address and the destination address can be Mobile Station International Subscriber Directory Numbers (MSISDNs) and the received message can be a Short Message Service (SMS) message. The processor can compare the source address of the received message to the destination address of the received message. The processor can determine a correlation between the source and destination addresses in response to determining the source address and the destination address of the received message are identical. In response to flagging the received message, the processor can instruct the communication interface to forward the received message to a messaging application server for further processing.

In further embodiments of the second aspect, a payload of the received message can include distribution information for use during the further processing. The distribution information can include an identifier associated with at least one recipient for the received message. The processor can be further configured to extract an identifier associated with a recipient from the flagged message and determine a message distribution channel associated with the recipient in accordance with the extracted identifier. The processor can instruct the communication interface to transmit the flagged message to the recipient through the determined message distribution channel.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating a chat server system;

FIG. 2 is a block diagram illustrating a multi-server chat system;

FIG. 3 is a block diagram illustrating a network view of an embodiment of the present invention;

FIG. 4 is a signaling diagram of an embodiment of the present invention;

FIG. 5 is a flow chart illustrating a method of the present invention; and

FIG. 6 is a block diagram illustrating a node of the present invention.

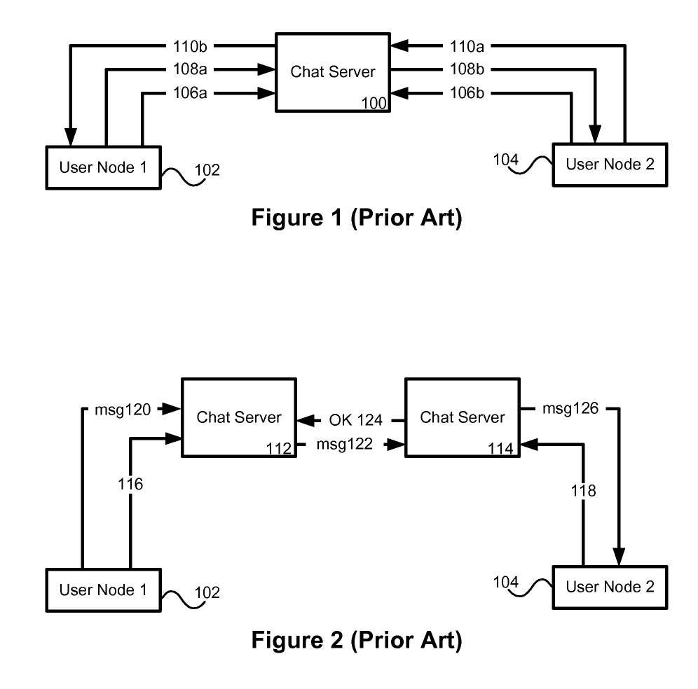

### DETAILED DESCRIPTION

The present invention is directed to a system and method for identifying a message for further processing and enabling a group messaging service across a plurality of platforms.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

Presented herein is a method and system that makes use of a resource such as a messaging application server to act as a distribution mechanism for each of the services and social networks that a group of users may be connected through. This resource can be network based, or it can be resident on a piece of end user equipment. For the purposes of improving availability and for simplifying the discussion below, a network implemented resource will be discussed, although those skilled in the art will appreciate that this is not intended to be limiting in scope. A user can trigger the messaging application server to act as a distribution mechanism for a message using the user's existing MSISDN and conventional SMS messaging. A network-based messaging application server can use user credentials to connect to each of the social networking services, or messaging platforms, that the user is registered with, on behalf of the user. Each contact that a user is connected with can be represented on a plurality of different messaging or social networking services. A network address book service can consolidate the contact information of each of the user's connections to provide a cross-platform database of the user's connections.

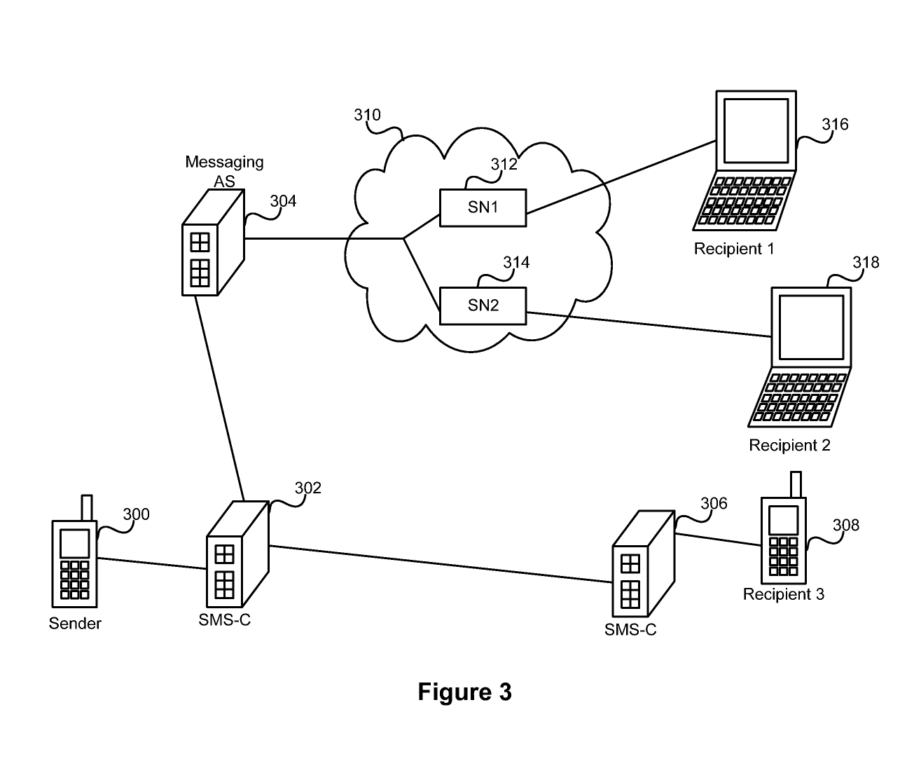

FIG. 3 is a block diagram illustrating a network view of an embodiment of the present invention. A user equipment (UE) 300 is in communication with an SMS-C 302 via conventional SMS messaging. The SMS-C 302 receives an SMS message from the UE 300, addressed to a destination address for delivery. An SMS message includes the following information: a “From” header field indicating the source address of the message; a “To” header field indicating the destination address for the message; and a payload including the content of the message. The SMS-C 302 can compare the “To” header and the “From” header for a received SMS message. The “To” header will contain the sender's address or identity (i.e. MSISDN) and the “From” header will contain the destination MSISDN. When the SMS-C 302 determines that the addresses in the “To” and “From” headers are identical, the SMS-C 302 will flag the received message for further processing, without delivering the message to the destination address. Further processing can include forwarding the received message to the Messaging Application Server (AS) 304.

In an embodiment of the present invention, an SMS message is received which is addressed from the sender to himself, and the SMS-C 302 forwards that message to the Messaging AS 304 for further processing and distribution. The SMS-C 302 can transmit the received message to the Messaging AS 304 without transmitting the message to the destination indicated in the “To” field (i.e. the sender UE 300).

The Messaging AS 304 can retrieve the payload of the received message to determine the intended recipient(s) and delivery accordingly. For exemplary purposes, the Messaging AS 304 may determine that the message is intended for three recipients. Recipient 1 can be connected to the sender through a first social network, SN1. The Messaging AS 304 connects through a network 310, such as the internet, to the social network server SN1 312. Messaging AS 304 may connect to SN1 312 through a gateway which may require authorization and authentication for access. The Messaging AS 304 can store user credentials for the sender to enable connection to a social network such as Facebook, Twitter, etc. The Messaging AS 304 can deliver the received message to the SN1 server 312. SN1 312 can then deliver the message to the UE 316 of Recipient 1 for display to the recipient. Similarly, Recipient 2 can be connected to the sender via a second social network SN2 314 and the message can be routed through the SN2 server 314 for delivery to the UE 318 for display to Recipient 2.

Recipient 3 can be connected to the sender through SMS messaging. The Messaging AS 304 can determine the MSISDN associated with Recipient 3 and forward the received message to the appropriate SMS-C 306 for delivery of the message to the UE 308 to which the MSISDN associated with Recipient 3 is assigned. The message can be routed to SMS-C 306 directly, or via SMS-C 302, using standard SMS protocols and process as will be readily understood by those in the art.

Based upon the interaction between the Messaging AS 304 and a plurality of different messaging platforms, a one-to-many messaging service can be enabled. The UE 300 of the user initiating the group message does not need to be connected to each of the different messaging platforms and/or social networks itself. The group messaging client on the UE 300 can embedded identity information for multiple recipients in the payload of an SMS message. An SMS message having identical “To” and “From” header fields is used to trigger the delivery of the message from the SMS-C 302 to the Messaging AS 304. The Messaging AS 304 can extract the identity information for the multiple recipients from the payload of the SMS message. The recipients do not need to have access to a common messaging platform. Instead, the Messaging AS 304 can select a messaging platform to reach each user on. A message sent from the sender's UE 300 through the Messaging AS 304 can be relayed into each of the relevant messaging platforms.

It should be noted that every time a message is received by the Messaging AS 304, it could determine which contacts are available on which messaging platforms to provide the best chance at delivering the message. This determination could be based on information stored in a network address book associated with the sender and presence information related to each of the recipients. If a group message recipient has left a social network, but either email or a phone number is available, the Messaging AS 304 could use either email or an SMS-based messaging delivery system to attempt to deliver the message.

It should also be noted that the Messaging AS 304 can be located inside or outside of the operator network. The functionality provided by the Messaging AS 304 could optionally be added to a modified SMS-C node, so that a single entity could both flag a received message for further processing and perform the further processing.

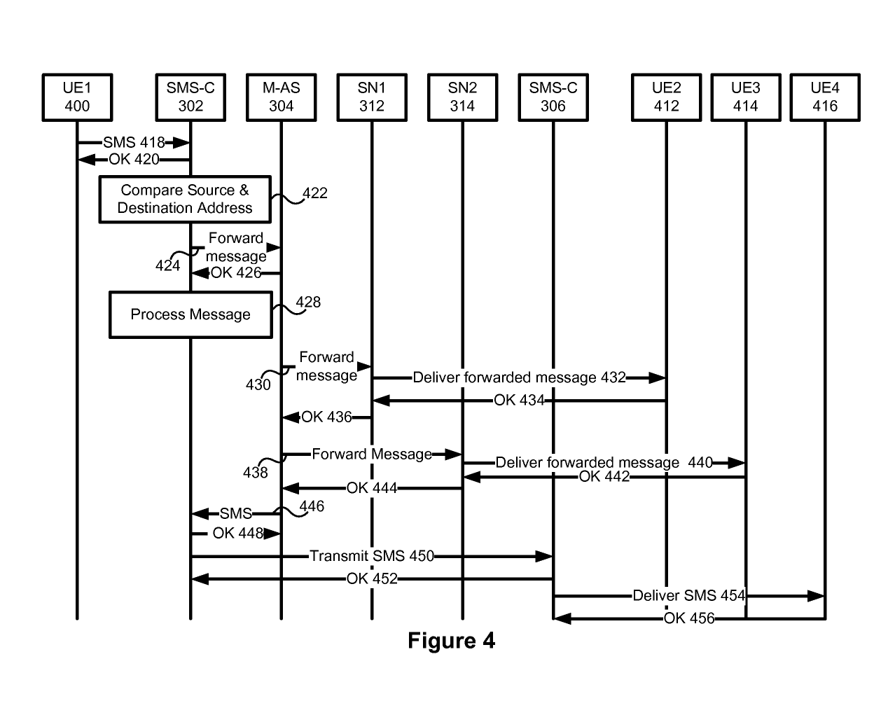

FIG. 4 illustrates a traffic flow for an embodiment of the present invention. A user uses mobile device UE1 400 to send an SMS message to a group of recipients, who can be selected from an address book or input manually. UE1 400 can use a messaging application or client to include identities of each of the recipients in the payload of the SMS message. The UE1 400 sends an SMS message 418 to the SMS-C 302. SMS message 418 includes a “From” header indicating the source address, a “To” header indicating the destination address, and a payload. The MSISDN associated with UE1 400 is inserted as both the source and destination addresses. The payload can include identifiers or addresses for each of the intended ultimate recipients, as well as the content of the message. SMS-C 302 returns an acknowledgement message 420 following the receipt of SMS message 418.

In step 422, the SMS-C 302 compares the “From” header to the “To” header of the received SMS message 418. If the content of these two headers is identical (i.e. the source address equals the destination address), the SMS-C 302 flags the message for further processing. Further processing can include forwarding the SMS message 424 to the Messaging AS 304. Messaging AS 304 returns an acknowledgement message 426 following the receipt of the forwarded SMS message 424. In step 428, the Messaging AS 304 performs the further processing by processing the payload of SMS message 424. The Messaging AS 304 can retrieve a list of recipients and the message content input by the sender from the payload of SMS message 424. In accordance with the retrieved recipients, the Messaging AS 304 determines the corresponding messaging distribution channel to deliver the message to each of the recipients.

The Messaging AS 304 can optionally determine through which channel or platform to deliver the message to each recipient by consulting a network address book. The network address book can be stored locally at the Messaging AS 304 or remotely accessible.

Alternatively, all information required to deliver the message to each recipient can be included in the payload, or body, of the received SMS message 424. For example, the payload of SMS message 418 may include a messaging protocol on top of the normal SMS transportation protocol that allows a list of recipients to be retrieved when the payload is processed.

The Messaging AS 304 determines that a first recipient should be contacted through social network SN1 312. The Messaging AS 304 forwards the message 430 to social network server SN1 312, which delivers message 432 to the recipient via device UE2 412. UE2 412 acknowledges receipt with OK message 434, and SN1 312 confirms delivery back to the Messaging AS 304 with OK message 436.

Similarly, the Messaging AS 304 determines that a second recipient should be contacted through social network server SN2 314. The Messaging AS 304 forwards the message 438 to social network SN2 314, which delivers message 440 to the recipient via device UE3 414. UE3 414 acknowledges receipt with OK message 442, and SN2 314 confirms delivery back to the Messaging AS 304 with OK message 444.

As previously discussed, SN1 312 and SN2 314 can be social network entities or servers that can be accessed through the internet. Each social network server can be connected to the internet through a gateway, and may have security requirements. The Messaging AS 304 can utilize user credentials to access the social network on behalf of the user.

The Messaging AS 304 determines that a third recipient should be contacted through SMS messaging. The Messaging AS 304 forwards the SMS message 446, addressed to the MSISDN associated with the third recipient, to the SMS-C 302. The SMS-C 302 returns acknowledge message 448 to the Messaging AS 304. SMS-C 302 can then look up the MSISDN of the third recipient in the corresponding Home Location Register (HLR) (not shown in FIG. 4) to determine how to deliver the message to the third recipient. The HLR is a central database that contains routing information indicating how to reach each mobile device that is authorized to use the network. For this example, a second, or terminating, SMS-C 306 is determined to be the serving SMS-C for the third recipient, UE4 416. SMS-C 302 forwards SMS message 450 to the second SMS-C 306 in the network. Receipt of SMS message 450 is acknowledged with acknowledgement message 452. The SMS-C 306 then delivers SMS message 454 to the device UE4 416 to which the MSISDN associated with the third recipient has been assigned. UE4 416 returns acknowledgement message 456 to SMS-C 306.

As will be readily understood by those skilled in the art, the Messaging AS 304 can forward the SMS message 446 to any SMS-C in the network that it has an agreement with. SMS-C 302 and SMS-C 306 may or may not belong to the same operator. Alternatively, SMS message 446 can be transmitted directly to SMS-C 306 or any other SMS-C that may reside in the network.

In the exemplary embodiment shown in FIG. 4, the Messaging AS 304 can send an SMS message, such as message 446, to an originating SMS-C when delivering to a recipient via SMS. The originating SMS-C contacts the HLR to resolve where to forward the SMS message. If the recipient is not present in the HLR, it means the SMS message can be forwarded to an external SMS-C. Based upon the MSISDN and service-level agreements among operators, the originating SMS-C can forward the SMS message to the next SMS-C. This process may be repeated several times until the terminating SMS-C is reached. When the recipient is present in the corresponding HLR, the terminating SMS-C shall be able to deliver the SMS to the recipient's device, which is attached to the network.

In conventional SMS messaging systems, an SMS-C is required to transmit a received message to the destination address indicated the “To” header field. Regardless of any relationship between the source and destination addresses, an SMS message will always be attempted to be delivered to the “To” address. In practice, a user can send an SMS message to himself and he will, in turn, receive that message from the SMS-C. In embodiments of the present invention, the SMS-C 302 flags the received message for processing and forwards it to the Messaging AS 304 without transmitting it to the recipient as indicated in the “To” field. As described above with respect to FIG. 4, SMS message 418 is addressed both to and from the MSISDN of UE1 400. However, UE1 400 does not receive a copy of SMS message 418 from the SMS-C 302.

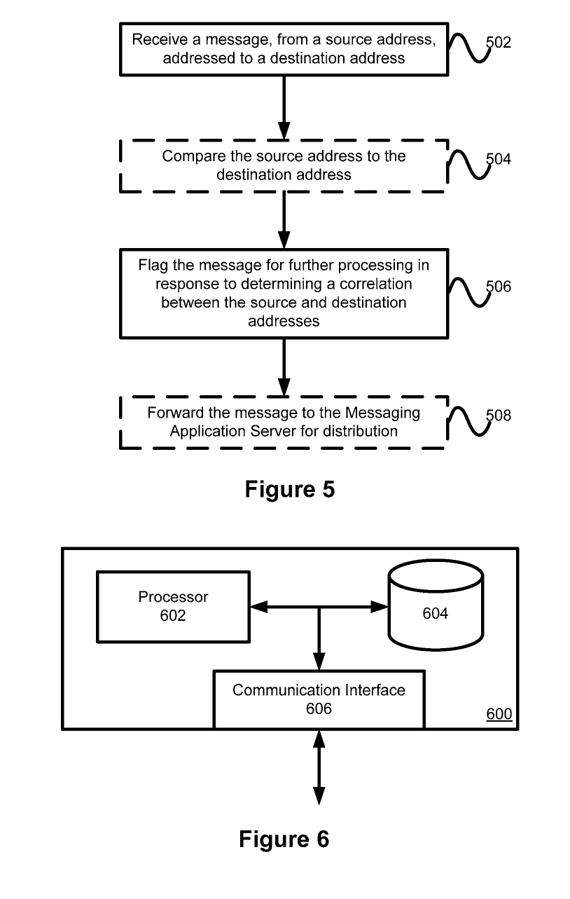

FIG. 5 is a flow chart illustrating a method for identifying a message for further processing. The method of FIG. 5 can be performed at a messaging center such as an SMS-C. The method starts at step 502 when a message is received from a source address. The message is addressed to a destination address. The message can be an SMS message, an email, an instant message or a message of another other communication system. The source and destination addresses can be MSISDNs. The source and destination addresses can be included in “To” and “From” headers of the received message. Optionally, in step 504, the source and destination addresses of the received messages are compared. In step 506, the received message in flagged for further processing in response to determining a correlation between the source and destination addresses. Determining a correlation can include determining that the source address and the destination address are identical. In alternative embodiments, the source address and the destination address need not be identical to determine a correlation between the two addresses. For example, a predetermined subset of digits in the source and destination MSISDNs could be compared to determine if there is a relationship between them.

The received message is flagged for further processing without transmitting the received message to the destination address. In step 508, the message can optionally be forwarded to a Messaging Application Server for the further processing, which can include distribution, in response to flagging the message for further processing. The payload of the received message can include distribution information for use during the further processing. The distribution information can include an identifier associated with at least one intended recipient for the received message. The further processing can include extracting the distribution information from the payload and forwarding the message to the recipients.

In an alternative embodiment, the step of further processing can be performed by the message center node itself The further processing can include extracting an identifier associated with a recipient from the flagged message, determining a message distribution channel associated with the recipient in accordance with the extracted identifier, and transmitting the flagged message to the recipient through the determined message distribution channel. Determining a message distribution channel can include determining a messaging platform through which the recipient can be contacted. The message platform can include a social network platform, an instant message based messaging platform or an email based messaging platform. The distribution channel can include an SMS based delivery channel. The message distribution channel can be determined in accordance with contact information associated with extracted recipient identifier. The contact information can be stored in an address book. Optionally, the message distribution channel can be determined in accordance with presence information for the recipient across a plurality of messaging platforms.

FIG. 6 is a block diagram of a messaging center node 600 which can be used to implement embodiments of the present invention as described herein. Node 600 can be an SMS-C. Node 600 includes a processor 602, a memory or instruction repository 604, and a communication interface 606. The communication interface 606 receives a message from a source address and addressed to a destination address. The message can be an SMS message and the source and destination addresses can be MSISDNs. The processor 602 can compare the source and destination addresses of the received message. In response to determining a correlation between the source and destination addresses, the processor 602 flags the received message for further processing without instructing the communication interface 606 to transmit the received message to the destination address. The determined correlation can be that the source and destination addresses of the received messages are identical. The received message can be stored in the memory 604 for further processing or future distribution. In response to flagging a received message for further processing, the processor 602 can instruct the communication interface 606 to forward the received message to a messaging application server for distribution. The payload of the received message can include distribution information for use during the further processing. The distribution information can include an identifier associated with at least one recipient for the received message, which can be extracted during the further processing of the received message.

The further processing of a flagged message can alternatively be performed by the processor 602. The processor 602 can extract the identity of a recipient, or a plurality of recipients, from the payload of a flagged message. The processor 602 can determine a message distribution channel through which the message contents can be delivered to the extracted recipient(s). The processor 602 can instruct the communication interface 606 to forward a copy of the received message to each of the extracted recipients.

It should be noted that while exemplary embodiments of the present invention have been described with respect to SMS messaging, they should not be considered limiting. The systems and methods as described herein can be applied to email, instant messaging or any other messaging service or platform. For example, receipt of an email message with identical source and destination addresses could be used to flag the message for further processing by the email server, without forwarding the message to the specified destination address. The email message could contain distribution and/or recipient information in its payload which could be extracted by performing the further processing.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for identifying a message for further processing, comprising:
receiving, at a messaging center, a message from a source address addressed to a destination address; and
responsive to determining a correlation between the source address and the destination address, flagging the received message for further processing without transmitting the received message to the destination address.

2. The method of claim 1, wherein the step of determining the correlation between the source address and the destination address includes determining the source address and the destination address are identical.

3. The method of claim 1, wherein the source address and the destination address are Mobile Station International Subscriber Directory Numbers (MSISDNs).

4. The method of claim 1, wherein the received message is a Short Message Service (SMS) message.

5. The method of claim 1, further comprising the step of comparing the source address of the received message to the destination address of the received message.

6. The method of claim 1, further comprising the step of forwarding the received message to a messaging application server for further processing, in response to flagging the received message.

7. The method of claim 1, wherein a payload of the received message includes distribution information for use by the further processing.

8. The method of claim 7, wherein the distribution information includes an identifier associated with at least one recipient for the received message.

9. The method of claim 1, further comprising the steps of:
extracting an identifier associated with a recipient from the flagged message;
determining a message distribution channel associated with the recipient in accordance with the extracted identifier; and
transmitting the flagged message to the recipient through the determined message distribution channel.

10. A network messaging center, comprising:
a communication interface for receiving a message from a source address and addressed to a destination address; and
a processor for flagging the received message for further processing without transmitting the received message to the destination address, in response to determining a correlation between the source and destination addresses of the received message.

11. The network messaging center of claim 10, further comprising a memory for storing the received message.

12. The network messaging center of claim 10, wherein the source address and the destination address are Mobile Station International Subscriber Directory Numbers (MSISDNs).

13. The network messaging center of claim 10, wherein the received message is a Short Message Service (SMS) message.

14. The network messaging center of claim 10, wherein the processor compares the source address of the received message to the destination address of the received message.

15. The network messaging center of claim 10, wherein the processor determines a correlation between the source and destination addresses in response to determining the source address and the destination address of the received message are identical.

16. The network messaging center of claim 10, wherein responsive to flagging the received message, the processor instructs the communication interface to forward the received message to a messaging application server for further processing.

17. The network messaging center of claim 10, wherein a payload of the received message includes distribution information for use during the further processing.

18. The network messaging center of claim 17, wherein the distribution information includes an identifier associated with at least one recipient for the received message.

19. The network messaging center of claim 10, wherein the processor is further configured to extract an identifier associated with a recipient from the flagged message; determine a message distribution channel associated with the recipient in accordance with the extracted identifier; and instruct the communication interface to transmit the flagged message to the recipient through the determined message distribution channel.
